(19) United States
(12) Patent Application Publication
(10) Pub. No.: US 2010/0005426 A1
(43) Pub. Date: Jan. 7, 2010

(54) Method for Identifying Phone Numbers and Alphanumeric Sequences

(76) Inventors: Benedict Van, Saratoga, CA (US); Stefan Sigmund, Weinheim (DE)

Correspondence Address: PILLSBURY WINTHROP SHAW PITTMAN LLP, P.O. BOX 10500, MCLEAN, VA, 22102, US

(21) Appl. No.: 11/619,583

(22) Filed: Jan. 3, 2007

Related U.S. Application Data
(60) Provisional application No. 60/872,274, filed on Dec. 1, 2006.

(51) Int. Cl. G06F 17/30; G06F 3/048

(52) U.S. Cl. 715/860; 707/6; 707/E17.108; 715/234; 715/760

(57) ABSTRACT

A method and system provides the ability to identify phone numbers and alphanumeric sequences in a text source such as a web page and format them and/or convert them into usable information. According to one aspect, the invention automatically identifies and formats phone numbers in web pages so that they can be automatically dialed using VoIP or PSTN phone services. According to other aspects, the formatted phone number can be provided to any network voice applications, such as voice-over IP (VOIP) solutions, voice chat, voice IM, and wireless, WiFi, and WiMax connections. According to additional aspects, the invention can be integrated with internet browsing applications to allow automatic dialing of phone numbers over VOIP services or PSTN services. According to still other aspects, the invention allows technical support, electronic commerce, customer support numbers, phone numbers for product ordering, etc., on company web pages to be identified and dialed with a mouse click. According to yet other aspects, a search engine provider using the invention can charge an advertiser for phone calls placed to the advertiser, which are far more valuable than “clicks” on advertiser links, thereby reducing the “click fraud” problem afflicting current search engine technology.

### CROSS-REFERENCE TO RELATED APPLICATIONS

The present invention is based on, and claims priority to, U.S. Provisional Appln. No. 60/872,274, filed Dec. 1, 2006, the contents of which are incorporated by reference herein in their entirety.

### FIELD OF THE INVENTION

The present invention relates to voice communications facilitated via network information, and more particularly to a method for identifying phone numbers and alphanumeric sequences from plain text and other data sources, and converts them into usable information.

### BACKGROUND OF THE INVENTION

Network voice communications, such as VoIP calls, voice chat and voice IM, have become increasingly popular, and have greatly supplemented—though not yet replaced—standard voice calls such as via the PSTN. Conventionally, to use an internet telephone service to place a telephone call, a caller uses a personal computer to access the internet or a private network. The personal computer is typically equipped with a web browser such as Microsoft Internet Explorer™ or Netscape Navigator™ for accessing a web page with graphical content. To specify a web site, the caller enters a uniform resource locator (URL) specifying both the server and the specific data (i.e. web pages) requested. The URL may specify a hypertext transfer protocol (HTTP) or another transfer protocol for communicating between the server and the browser. In conventional internet telephone service, the caller accesses the web site of an internet telephone service provider and enters the telephone number of the destination communication device on a “console” (e.g., a graphical caller interface) of the provider's web site. The internet telephone service provider then dials the telephone number. However, in many instances, the caller may navigate to a web page containing telephone numbers which the caller wishes to dial. For example, the caller may navigate to the web page of a local restaurant which includes the telephone number of the restaurant. To place a telephone call to the restaurant using internet telephony, such as a dinner reservation, the caller has to record the telephone number in some manner and go to his desired internet telephone service provider by specifying the provider's URL. The caller then enters the telephone number into the console at the web site of the telephone service provider for dialing the telephone number. This telephone dialing process is very cumbersome, particularly when the caller is viewing a page containing several telephone numbers which he wishes to dial in sequence.

Some prior art such as U.S. Pat. Nos. 6,834,048, 6,870,828 and 6,938,067 and U.S. patent publications 2004/0234049 and 2005/0097189 have made attempts to simplify the above process by allowing telephone numbers displayed in various formats to be more easily dialed. Also, some types of smart phones such as Blackberry can detect and enable phone numbers to be dialed from displayed text, albeit not from web pages. However, many drawbacks remain. For example, there remains a need for a system that can effectively capture and dial international phone numbers and vanity numbers. Moreover, the present inventors recognize that the ability to enable automatic voice calling from web pages presents additional possibilities that are not addressed by current technology. These possibilities include reducing the need for toll free numbers through VoIP calls from web pages, and reducing click fraud by recording clicks that initiate voice calls from web pages.

Accordingly, there remains a need in the art for a method and system that can overcome these and other problems.

### SUMMARY OF THE INVENTION

In accordance with certain general aspects, the invention provides the ability to identify phone numbers and alphanumeric sequences in a text source such as a web page and format them and/or convert them into usable information. According to one aspect, the invention automatically identifies and formats phone numbers in web pages so that they can be automatically dialed using VoIP or PSTN phone services. According to other aspects, the formatted phone number can be provided to any network voice applications, such as voice-over IP (VOIP) solutions, voice chat, voice IM, and wireless, WiFi, and WiMax connections. According to additional aspects, the invention can be integrated with internet browsing applications to allow automatic dialing of phone numbers over VOIP services or PSTN services. According to still other aspects, the invention allows technical support, electronic commerce, customer support numbers, phone numbers for product ordering, etc., on company web pages to be identified and dialed with a mouse click. According to yet other aspects, a search engine provider using the invention can charge an advertiser for phone calls placed to the advertiser, which are far more valuable than “clicks” on advertiser links, thereby reducing the “click fraud” problem afflicting current search engine technology.

### BRIEF DESCRIPTION OF THE DRAWINGS

These and other aspects and features of the present invention will become apparent to those ordinarily skilled in the art upon review of the following description of specific embodiments of the invention in conjunction with the accompanying figures, wherein:

FIG. 1 is a block diagram illustrating example general aspects of the invention;

FIG. 2 is a block diagram illustrating example general aspects of the invention in alternative detail;

FIG. 3 is a functional block diagram of a phone number identification and formatting module according to certain aspects of the invention;

FIG. 4 is a flowchart illustrating an example methodology implemented by a phone number identification and formatting module according to certain aspects of the invention;

FIG. 5 is a flowchart illustrating an example pattern search methodology according to aspects of the invention;

FIG. 6 is a flowchart illustrating an example part separation methodology according to aspects of the invention;

FIG. 7 is a flowchart illustrating an example part verification methodology according to certain aspects of the invention;

FIG. 8 is a block diagram illustrating an example client side implementation of the invention for initiating network voice calls;

FIG. 9 is a block diagram illustrating an example client side implementation of the invention for initiating PSTN voice calls;

FIG. 10 is a block diagram illustrating an example server side implementation of the invention; and

FIG. 11 is a block diagram illustrating an example server side implementation of an embodiment of the invention including the ability to monetize clicks for initiating phone calls enabled by the invention.

### DETAILED DESCRIPTION OF THE PREFERRED EMBODIMENTS

The present invention will now be described in detail with reference to the drawings, which are provided as illustrative examples of the invention so as to enable those skilled in the art to practice the invention. Notably, the figures and examples below are not meant to limit the scope of the present invention to a single embodiment, but other embodiments are possible by way of interchange of some or all of the described or illustrated elements. Moreover, where certain elements of the present invention can be partially or fully implemented using known components, only those portions of such known components that are necessary for an understanding of the present invention will be described, and detailed descriptions of other portions of such known components will be omitted so as not to obscure the invention. In the present specification, an embodiment showing a singular component should not be considered limiting; rather, the invention is intended to encompass other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

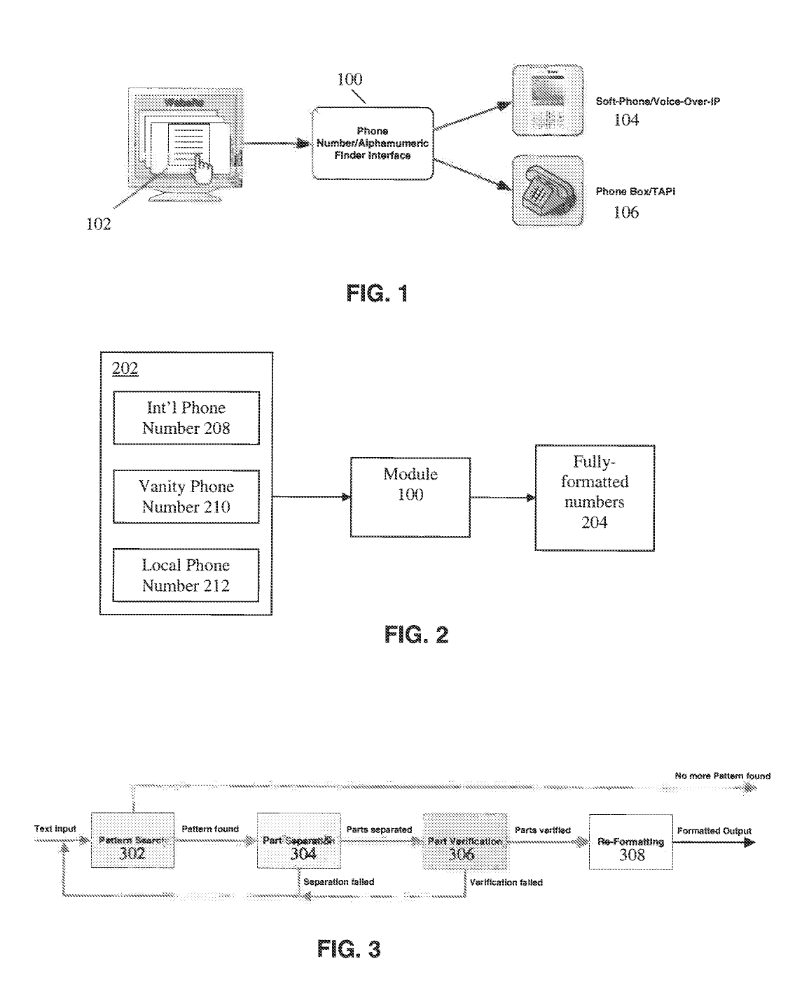

Certain general aspects of embodiments of the invention are illustrated in FIG. 1. In this example, the invention is largely embodied by a Phone Number/Alphanumeric Finder module 100. In a preferred embodiment illustrated in FIG. 1, module 100 extracts numeric and alphanumeric strings corresponding to phone numbers from the text source for a displayed web page 102 and converts them into reusable information. More particularly, module 100 scans the text source for numeric phone dialing patterns (i.e. phone numbers), as well as alphanumeric phone dialing patterns (e.g. vanity numbers). Detected patterns will be verified, based on international and other dialing rules, and converted into well formatted dialing information.

As further shown in FIG. 1, the extracted and formatted phone numbers are suitable for many applications. For example, the numbers can be used to control software-based phone applications 104 and/or hardware phone devices 106 to start automatic dialing. This interface can thereby provide internet web sites with the ability to start phone calls with potential customers by a single mouse click. Extracted and formatted phone numbers can also be used in non-dialing applications where phone numbers are useful such as database or directory applications.

FIG. 2 is a block diagram illustrating certain general aspects of the invention in alternative detail. As illustrated in FIG. 2, module 100 extracts data corresponding to phone number information (e.g. alphanumeric strings) in various formats from a document 202 and outputs a list 204 of fully-formatted phone numbers. As further illustrated in FIG. 2, the various phone number formats can include international phone numbers 208, vanity phone numbers 210, and local phone numbers 212. It should be apparent that other types of numbers are possible, and that it is possible that not all of these various phone number formats will appear in one document 202, and that module 100 can act on many different documents either in sequence or in parallel. It should be further apparent that there may be from anywhere to zero to many of each of numbers 208, 210, 212 in a single document 202. It should be still further apparent that although “fully-formatted” implies that the number is capable of being directly dialed and/or utilized as a phone number without further verification and/or formatting, it is possible that further verification and/or formatting will not change the number 208, 210, 212 in any substantive way.

Document 202 is typically an HTML or similar markup language page that is capable of being rendered by a web or similar browser. However, the invention is not limited to this embodiment, and document 202 can include any data source or stream that can provide or be used to present text, with or without conversion, on a text-based or graphical display, browser, phone display, PDA display, and/or document 202 can include any document containing formatted or unformatted (e.g. plain text) text, such as TXT, HTML, XML, WML, RTF, MS Word and other types of documents. Accordingly, the term “document” should be construed in its broadest possible sense, and should not be limited to a text based paper or electronic document.

International phone numbers 208 are usually divided into three parts, the country code, the area code and the local number part. A unique phone number should contain all three parts. In this case, the number is reachable from everywhere in the world, using the dialing prefix of the appropriate caller and/or called party location.

The final formatted phone number corresponding to an international phone number 208 may further include a dialing prefix in addition to the international phone number. The dialing prefix can be indicated by a single+sign {plus), since international dialing rules can be different depending on the country where the caller is located. The individual parts are preferably separated by commonly used characters, such as periods or dots (“.”) or dashes (“−”)to make the entire number easier to read. The final number is thus represented as:

International dialing prefix+<countrycode>−.<areacode>−.<localnumber>

Example final international phone number: +44-321-1234567

Example final dialing string from US locations: 011443211234567

Vanity numbers 210 are phone numbers which also spell something with the corresponding numbers on the phone keypad. Vanity numbers detected by the invention can include 7, 10, 11-digit numbers (i.e. numbers in the form of MMM-MMM, (NNN) MMM-MMMM and N-(NNN)-MMM-MMMM, where N is a number between 0 and 9, and M can be a between 0 and 9 or a letter between A and Z. Vanity numbers are often easier to remember than their numeric mapping. This number format is frequently used on company contact pages to provide easy to remember contact information to the customers.

According to certain aspects of the invention, module 100 is able to automatically map alphanumeric characters corresponding to vanity phone numbers to the corresponding numeric number, to get a usable phone number for further verification. The letters used in vanity numbers are mapped as follows:

TABLE 1

| Vanity Letters | Numeric |
|---|---|
| A, B, C | 2 |
| D, E, F | 3 |
| G, H, I | 4 |
| J, K, L | 5 |
| M, N, O | 6 |
| P, Q, R, S | 7 |
| T, U, V | 8 |
| W, X, Y, Z | 9 |

So, for example, the vanity number 1-800-IPPHONE will be converted by module 100 to the numeric number 1-800-4774663.

Local phone numbers 212 include phone numbers that, in general, are accessible without international dialing rules and/or cannot be accessed from outside the country as dialed. Accordingly, for the U.S., local numbers 212 include 7, 10, 11-digit numbers (i.e. numbers in the form of NNN-NNNN, NN) NNN-NNNN and N-(NNN)-NNN-NNNN, where N is a number between 0 and 9). It should be apparent that numbers 212 need not be limited to numbers within a local exchange, but could include numbers in various area codes within a country, toll-free numbers (e.g. 800 and 888 numbers), and numbers with special prefixes such as certain VoIP numbers.

Fully formatted numbers in list 204 can be all the numbers identified in document 202. It should be apparent that list 204 may only contain one number. Moreover, it is not necessary for an entire list to be output after processing a single document 202, but the operation can be performed in parallel for many documents, and/or the list 204 can be populated one at a time as numbers are identified. Moreover, the list need not correspond to an entire document 202, but can be filled selectively, as in a “find/next” or other selective operation.

According to certain aspects mentioned above, numbers in list 204 are strings consistent with a standardized format for use in dialing or other applications. In one example, the transformation of the textual form of a phone number into a structured definition would detecting and extracting an unformatted string of text from a document, for example, the string “<html>Phone: +1 (408) 123 4567 </html>” from a web page, and converting the detected unformatted string into a formatted phone number comprising the digits 1.408.1234567. Various alternative final formats will be described herein.

FIG. 3 is a functional block diagram illustrating an example implementation of a phone number finder module 100. In this example implementation, the module 100 is implemented by four sub-modules 302-310. These sub-modules implement a four-step chain as described in more detail below. Only number patterns that have passed the entire chain are indentified and output as a valid phone number in this example implementation. As can be seen in the drawing, the workflow is discontinued as soon as one of the required rules is not fulfilled.

Sub-modules 302-310 can be implemented as software executing on a client or server in a client-server network architecture, or distributed between two or more components in such an architecture. In one preferred implementation to be described in more detail below, sub-modules 302 are implemented as a plug-in to a browser such as Internet Explorer. However, the invention is not limited to this example architecture or implementation, and implementation details for various alternative configurations will become apparent to those skilled in the art after being taught by the examples provided below.

Search sub-module 302 performs a full text search over the entire text source. The search algorithm is looking for everything which looks like a numeric or alphanumeric phone number pattern. Found patterns are forwarded to the next phases for further processing. Search sub-module 302 also indicates when the entire text source has been searched and no more patterns are found.

Separation sub-module 304 tries to separate the detected text pattern into the three parts of an international phone number. Missing parts are completed automatically, if possible. The process continues to the next phase if the separation module returns complete values for all three parts. Otherwise, the found pattern will be discarded.

Verification sub-module 306 checks the completed phone number parts from sub-module 304 based on known dialing rules and a database of international country and area codes. The number will be treated as a valid phone number if all completed parts adhere to reliable criteria.

Formatting sub-module 308 is only executed for phone numbers determined to be valid by sub-module 304. At this point, the individual parts of the found phone number will be merged into a well formatted phone number. This phone number is the final result of the whole extraction process.

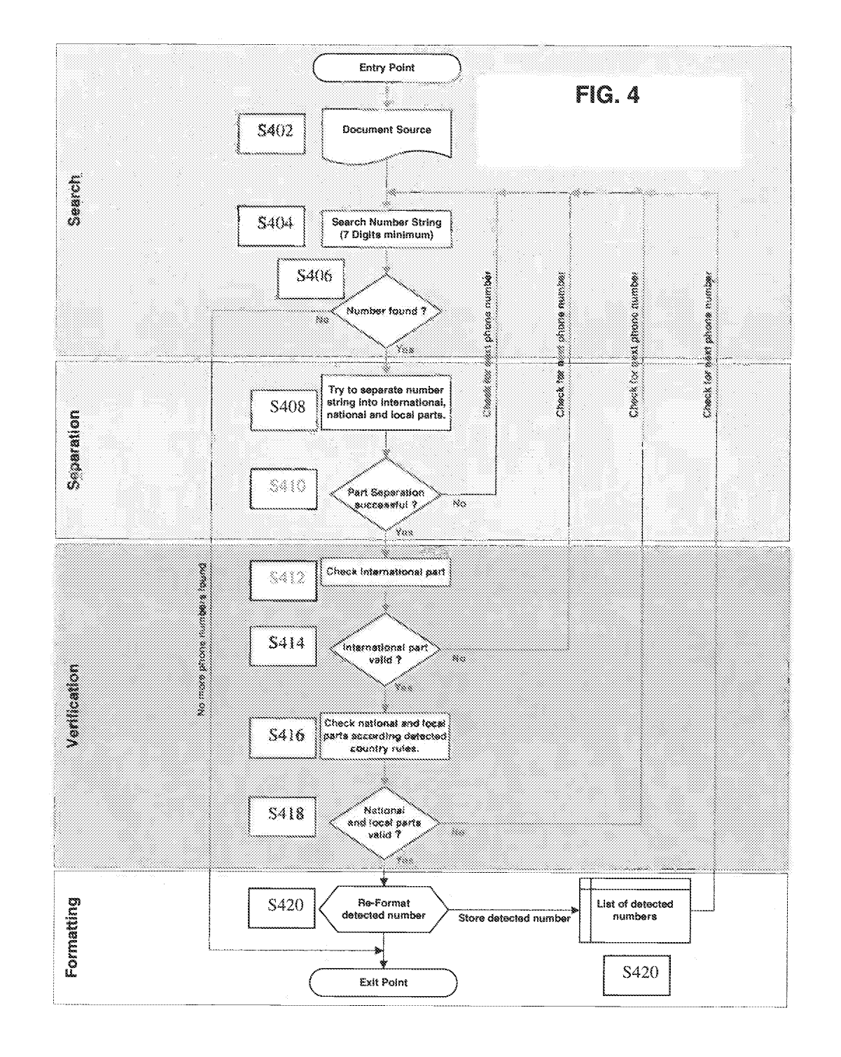

One example method of operation that can be performed by the above-described sub-modules for phone number extraction from a document is shown in the flow chart in FIG. 4. In this example, the document is an HTML page. The invention is not limited to extracting phone numbers from a text source comprising an HTML page, and those skilled in the art will understand how to practice the invention using other types of documents based on the foregoing and following descriptions. Moreover, this example illustrates an embodiment where an entire page is processed in one sequence to find all possible phone numbers. Other embodiments will become readily apparent, such as finding one phone number at a time, for example in a “find/next” or other selection operation.

As shown in FIG. 4, processing begins in step S402 by receiving the HTML document. In certain implementations, this can include HTML decoding, which involves stripping out HTML tags to leave only text between tags. It should be apparent that many alternatives are possible, such as ignoring HTML tags or other similar known non-text information while searching the document, and this operation can depend on the type of document to be parsed.

In step S404, processing continues by performing a full text search of the text source to find the next text sequence. This includes looking for everything which looks like a numeric or alphanumeric phone number pattern. If a pattern is found, as determined in step S406, processing continues to further process the pattern. Otherwise, processing ends.

In step S408, processing continues by trying to separate the detected text pattern into the three parts of an international phone number. If, as determined in step S410, the pattern contains or can be completed to have values for all three parts, processing continues to the next phase. For example, if a pattern has no country code, it can be a potentially valid U.S. phone number so it is completed to have a “null” international part or some type of flag indicating that it is a potentially valid U.S. number. Alternatively, a “1” is placed in the country code part for 11-digit U.S. dialing. Otherwise, the found pattern will be discarded, and processing returns to step S404 to find the next pattern.

In step S412, processing continues by checking the completed phone number parts from step S408. The number will be treated as a valid phone number if all completed parts adhere to reliable criteria. First, in step S412, the international part is compared to known dialing rules and a database of international country and area codes to determine if it is valid. Alternatively, this step may be skipped if the previous processing determined that the pattern was a potentially valid non-international phone number. If the international part is valid, or if the pattern is a potentially valid U.S. phone number, as determined in step S414, processing continues. Otherwise, the number is discarded and processing returns to step S404 to find the next pattern in the text source. In step S416, the remaining area code and/or local parts of the number are compared to known rules corresponding to the country in the validated country part of the number. For example, if the previous processing determined that the number was not an international number, the remaining parts are checked to see if they can match U.S. dialing rules. If it is determined in step S418 that the remaining parts are valid, processing continues to the next phase. Otherwise, processing returns to step S404 to find the next pattern in the text source.

Step S420 is reached only when phone numbers extracted from the document are determined to be valid by the prior processing. In this step, the individual parts of the found phone number will be merged into a well formatted phone number. This phone number is then added to the list of detected phone numbers from the document (step S422), and processing returns to step S404 to find the next pattern in the text source.

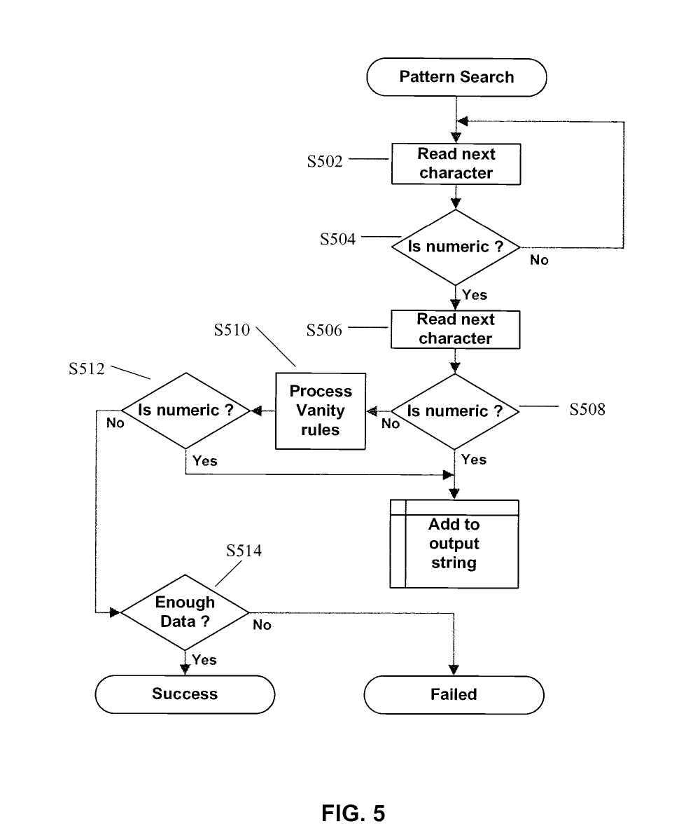

An example process for performing a pattern search as shown in step S404 of FIG. 4 is described in more detail in FIG. 5.

As shown in FIG. 5, in this example, the process is done in two general parts. The first general part is to find a numeric character which occurs directly behind a separator, for example a space, tabulator or line feed. Accordingly, in step S502, the next character in the document is read. In step S504, it is determined whether the character is numeric, and if so, whether the previous character was a separator. If neither of these tests are successful, processing returns to step S502 to read the next character. Otherwise, processing continues to the second pattern searching part.

In the second general pattern searching part, the text behind the found number will be parsed for more numeric characters or characters that match the vanity number rules, to attempt to obtain a numeric string that has enough numbers to possibly correspond to a phone number. Accordingly, in step S506, the next character from the text source is read. This next character is then checked in step S508 to see if it is numeric or a separator such as a space or dash. If so, it is combined with the previously found character(s) in an output string and processing returns to step S504 described above. If the next character is not numeric or a separator, processing continues to step S510, where vanity rules are applied to attempt to map the next character to a numeric character. If this can be done, as determined in step S512, the number is combined with the previously found character(s) in the output string and processing returns to step S504 described above. Otherwise, processing continues to step S514, where it is determined whether the output string contains enough numeric characters to support a phone number. For example, this step can determine whether the string contains at least 7 numeric digits. If there are enough numeric characters, a successful result is determined, and the output string is forwarded to the next phase. Otherwise, a failure condition is declared, and the output string is discarded and processing returns to step S502.

It should be apparent that steps S502 and S506 can include processing to determine whether the end of the text source has been reached without any additional valid text patterns being found, and returning an end of text condition.

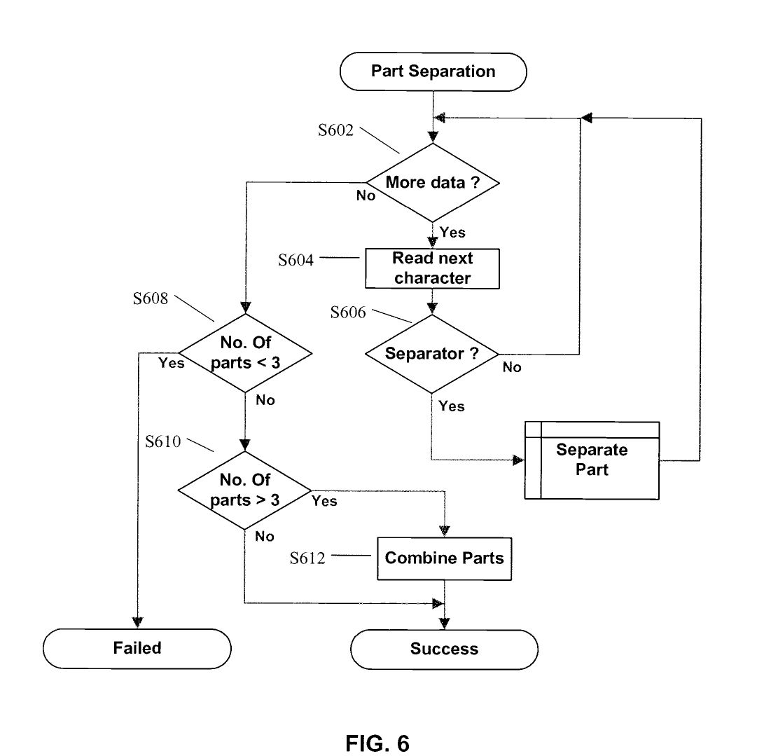

An example process of performing part separation as shown in step S408 of FIG. 3 is illustrated in more detail in FIG. 6. This process generally involves trying to separate the given phone number pattern into country code, area code and the local number part. The separation is done because of possible separators within the number string. These separators are characters like space, tabulator, dot, dash, slash, line feed, parenthesis or the plus sign.

As shown in FIG. 6, processing begins in step S604 where the first/next character in the string provided by the previous processing are read (unless the end of the string has already been reached as determined in step S602, to be described below). If it is determined in step S606 that the next character is a separator, the numeric characters preceding the separator are extracted from the output string and identified as a part. After the part extraction, or if the next read character was not a separator, processing then returns to step S602.

In step S602, it is determined whether the end of the string has been reached. If not, processing continues to step S604 to read the next character. Otherwise, processing continues to step S608.

In step S608, it is determined whether the number of numeric parts in the string provided by the pattern search process is less than 3. In this example embodiment, the minimum number of parts is 3, which would be the case for a valid 10-digit phone number including an area code. However, it is possible in other embodiments to have parts less than 3. For example, other embodiments might allow for local 7-digit phone numbers where the area code is known or can be readily determined from the document or other information, in which case it is automatically added to extend the 7-digit phone number to a 10-digit number and 3 parts. Returning to FIG. 6, if the number of parts is less than 3, a failure condition is returned. Otherwise, processing continues to step S610.

In step S610, it is determined whether the number of numeric parts in the string provided by the pattern search process is greater than 3. This could occur where the string includes a country code. This could also occur where, for example, a valid 10-digit number included more than 2 separators and/or where several separators occurred in sequence (e.g. a dash followed by a space). If the number of parts in the string is greater than 3, processing continues to step S612, where the parts are merged and/or recombined into 3 parts in a manner that yields the best combination of parts according to international phone number rules. For example, the first two parts are retained, and the remaining parts are merged into one part. As another example, if the first part is not a country code but an area code, the country code is replaced with a “1,” the area code is set as the second part, and the remaining parts are merged into a local number. It should be apparent that many additional and/or alternative merging operations are possible. After this merging operation, or if the number of parts was determined to be 3, a successful result is returned.

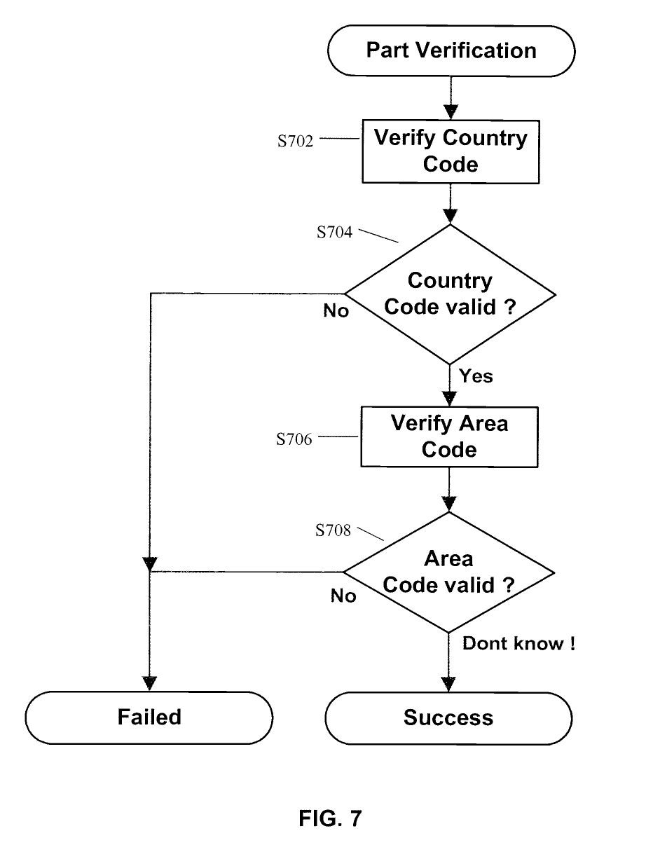

An example process of performing part verification as shown in steps S412-S418 of FIG. 4 is illustrated in more detail in FIG. 7. This process includes verifying the given country cods as well as the area code, if possible.

As shown in FIG. 7, processing begins in step S702 by attempting to perform country code verification. The country code verification can be done by comparing the first detected part of the string to a built-in list of all valid country codes in the world. Since this list is straightforward, the verification of the country code may not be very complicated. The verification process will fail immediately if the given country code was not found in the list or is not a “1” (as determined in step S704), and an error condition is returned. Otherwise processing continues with area code verification in step S706.

The verification of the area code is conditional upon the detected country. The area codes in some countries are easy to verify, since they follow clear rules. Area codes in North America for instance always have 3 digits. This is easy to handle. Other countries have area codes with variable length or they have no area code at all, like Hong Kong. A positive result of the area code verification is not suitable to validate a number pattern, but it can be utilized to nullify the whole term. Accordingly, if it is determined in step S708 that the area code is not necessarily invalid, a successful result is returned.

An example process of performing re-formatting as shown in step S420 of FIG. 4 is now described in more detail. In embodiments, the formatting process is quite simple. It is just a combination of the individual phone number parts. The numeric parts can then be separated by single characters, e.g. single dots. For example, where the resulting number consists of “1” for the country part, “408” for the area code part, and “1234567” for the local part, this is formatted to 1.408.1234567. This format represents an ideal starting point for the usage of the number in dialing applications such as within unique resource locators for VoIP dialing, for example: voipto://1.408.1234567.

It should be apparent that various other alternative formatting operations can be performed, depending on the target application, dialing location, phone provider, etc. Alternatively or additionally, formatting can be handled by application interfaces, and can possibly include adding prefixes such as “9” for dialing out, “011” for dialing international numbers, and various other dialing information that may be automatically added or manually added using dialogs with a user, for example.

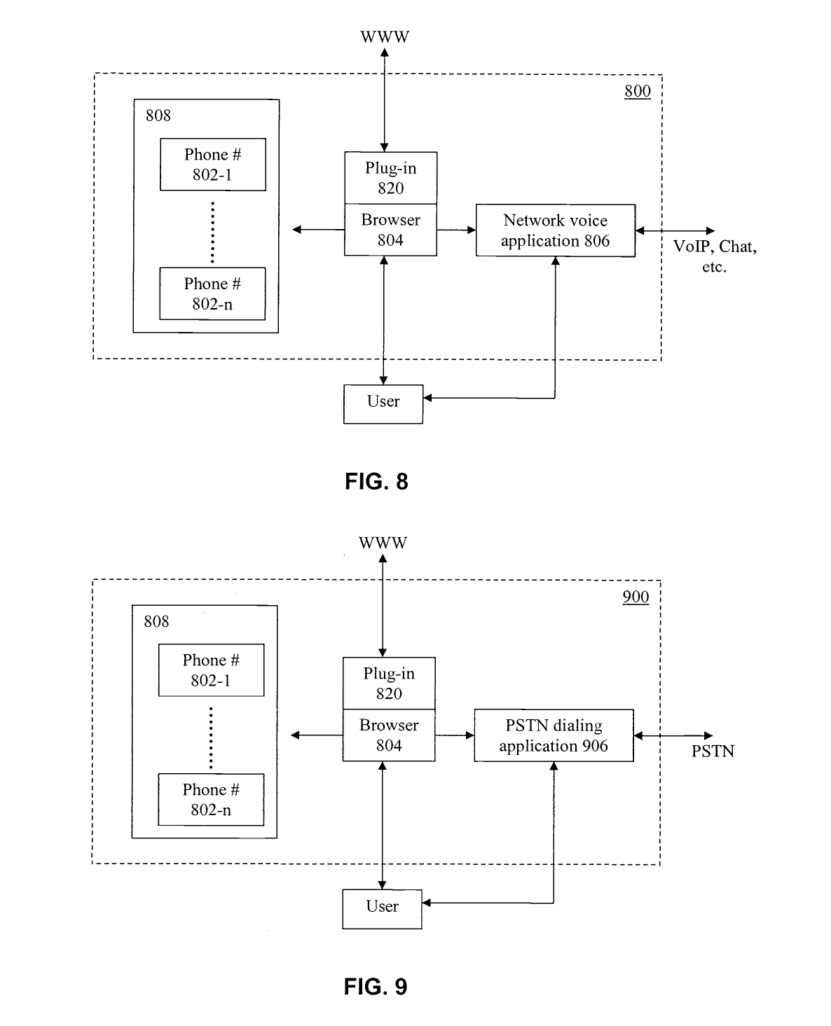

FIGS. 8 and 9 illustrate certain implementation aspects of the invention in further detail. As set forth more generally above, the result of processing performed by module 100 is one or more well formatted phone numbers. Enhanced by the appropriate local dialing rules, the phone number(s) can thus be used to control a variety of voice call dialing and other applications.

As shown in FIG. 8, the invention is embodied in a client device 800, such as a desktop, laptop or notebook computer, PDA, smart phone, network appliance, Blackberry, etc. Device 800 includes a display 808 such as a flat screen or other monitor, embedded LCD panel, etc. Device 808 also includes browser functionality 804 for accessing the World Wide Web.

In this example implementation, module 100 is embodied by a parser 820. In Windows Explorer embodiments, parser 820 can be implemented using a COM object. In other browser embodiments such as Mozilla Firefox, parser 820 can be implemented using plug-in mechanisms based on XML and JavaScript. Those skilled in the art will understand various implementation alternatives based on the present disclosure. For example, the phone number identification functionality of the invention can be accessed via a browser toolbar to allow identification and dialing of phone numbers in web pages requested by a user through browser 804 and displayed on display 808. Automatically or as selectively requested by the user, parser 820 can identify and change the display of phone numbers 802-1 to 802-n on display 808. For example, detected numbers can be highlighted using underlining, special colors, etc. The type of highlighting can be configured by the user.

In this example, the identified and formatted phone number 802 can be used to integrate with network voice applications 806, such as voice-over IP (VOIP) solutions, voice chat applications, and/or wireless, WiFi, and WiMax connections. For example, detected numbers can be replaced with a link (e.g. “voipto:1.222.3334444”), that when clicked, automatically launches a VoIP call using a VoIP dialing application configured to launch from or operate with the browser (e.g. huavoip.exe “1.222.3334444” when the HereUAre VoIP application is registered as the voipto protocol handler in the browser environment).

As shown in FIG. 9, in an alternative embodiment of a client device 900, the phone number strings identified by parser 820 can also be used by other types of voice applications to control placing telephone calls via the PSTN, for example through land or cellular PSTN (including PSTN service that is provided with broadband services such as DSL, ISDN, Cable DSL, WiFi, WiMAX, etc.) The formatted phone number string in this case provides a software interface to initiate an automated dialing process. For example, many operating systems such as Windows provides a telephone interface (TAPI) that allows applications to control external phones or phone boxes. PSTN dialing applications can be called by a special command line (e.g. dial.exe “1.222.3334444”) when a detected number in a web page is indentified and clicked by a user. The called application, using the TAPI interface, could open a phone connection using the TAPI command lineMakeCall as follows: lineMakeCall(lineHandle, callHandle, “+1.222.333444”, 0, NULL).

It should be apparent that the functionality of devices 800 and 900 is not necessarily exclusive, but that they can be integrated together in a common device.

It should be further apparent that since the formatted phone number string, returned by module 100 represents a regular phone number, it is suitable to use in any one of a great number of presently known and future ways in addition to voice call dialing or initiation. For example, database applications handling structured phone information can treat the given phone number string as a real international phone number, without the requirement of any additional pre-processing. As another example, the module 100 can provide further functionality for inserting the number into a phone directory or contact list, either automatically or through dialog boxes or other interaction with the user.

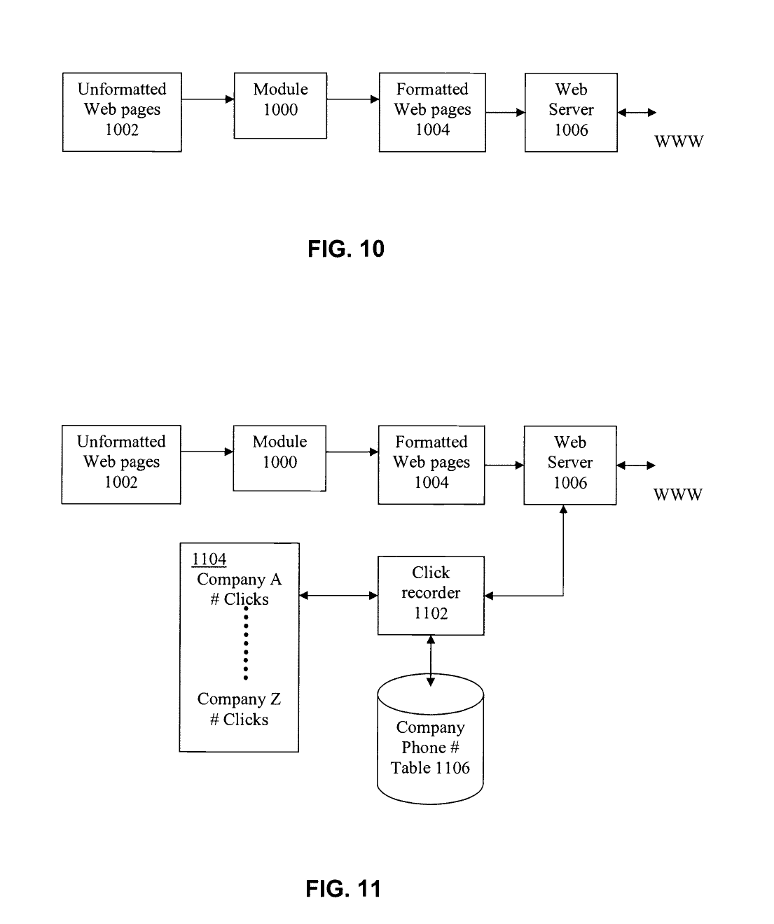

FIG. 10 illustrates additional aspects of the invention in alternative detail. As set forth above in an example implementation of this technology, direct dialing from phone numbers embedded in web sites is enabled. The invention can instantly recognize phone numbers or alphanumeric sequences in web pages.

In this example implementation, the module 1000 incorporating the phone number identification and formatting aspects of the invention is provided on the server side of client-server architecture, and acts to identify phone numbers in unformatted web pages 1002 and convert them into formatted phone numbers according to the invention in formatted web pages 1004 that are served by a web server 1006 to clients on the World Wide Web. In an example where web server 1006 is incorporated in a company's web site, technical support, electronic commerce, customer support numbers, phone numbers for product ordering, etc., can be identified and dialed with a mouse click. This implementation is applicable to web pages served by a variety of servers and applications, including search results, advertisement postings and directories, ecommerce sites, etc. Accordingly web server 1006 can include a company's own web server, or web server 1006 can be included in a search engine server (e.g. Yahoo, Google, etc.), or other third party directory and advertising servers (e.g. VoIP directories and services). According to this aspect of the invention, a company using the present invention is thus able to replace, and perhaps eliminate “800” numbers by facilitating easy internet phone number location and dialing for persons searching for the company. This reduces phone service costs to owners of businesses by replacing traditional phone lines with VOIP connections.

FIG. 11 illustrates additional aspects of the invention in alternative detail. The present inventors recognize that ability to identify and dial phone numbers found on web pages facilitates additional advantages. In general, instead of, or in addition to, paying for advertising based on “clicks” as currently done with conventional search engines, a company can use the present invention to provide phone numbers to clients and potential clients, and record and pay for the number of clicks made on the numbers formatted by the invention. Accordingly, as shown in FIG. 11, web server 1006 can include functionality for receiving information regarding clicks on identified phone numbers in formatted web pages 1004. This information is provided by click recorder 1102, which updates the number of clicks on phone numbers recorded for one or more companies in an account 1104.

In one example implementation, web server 1006 is included in a VoIP service that can also provide a search engine capability. In response to search requests from VoIP subscribers and/or other requests for pages associated with advertisers and other companies, formatted web pages 1004 are provided by web server 1006. The service further includes a table 1106 that associates phone numbers that are included in formatted web pages 1004 with the companies to which they are connected. Accordingly, when a VoIP subscriber uses the VoIP service to call a phone number using the VoIP service, in addition to facilitating the call, click recorder 1102 looks up the company associated with the phone number, and the call information is recorded for that company in account 1104.

Accordingly, in this and similar example implementations, when module 1000 is integrated with a search engine, a company can advertise its products or services through a search engine provider that uses the present phone number identification invention with a click-to-call feature. To monetize this service, the search engine provider can charge the advertiser for phone calls placed to the advertiser as recorded in account page 1104, which are far more valuable than mere “clicks” on advertiser links. In addition, this provides full accountability for phone calls made by individuals to an advertiser's phone numbers because the search engine provider can provide verification of calls actually made. Thus, the “click fraud” problem is reduced.

It should be apparent that many alternative implementations to that described above in connection with FIG. 11 are possible, and the invention is not limited to implementations where server 1006 is hosted by a VoIP service provider. Moreover, the functionality of module 1000 need not be co-located with the functionality of click recorder 1102, and other mechanisms for detecting clicks on formatted web pages 1004 may be used, such as special URLs, scripts, re-directs, and other techniques well known in the art.

Although the present invention has been particularly described with reference to the preferred embodiments thereof, it should be readily apparent to those of ordinary skill in the art that changes and modifications in the form and details may be made without departing from the spirit and scope of the invention. It is intended that the appended claims encompass such changes and modifications.

What is claimed is:

1. A method comprising:
receiving a text source;
searching the text source for a pattern;
separating the pattern into parts corresponding to a telephone number; and
verifying whether the separated parts together form a valid telephone number.

2. A method according to claim 1, further comprising:
formatting the separated parts into an output if they form the valid telephone number; and
providing the formatted output to a voice application.

3. A method according to claim 2, wherein the voice application is a VoIP application.

4. A method according to claim 2, wherein the voice application is a PSTN application.

5. A method according to claim 2, further comprising:
highlighting the text pattern corresponding to the formatted output on a display, wherein the providing step is performed in response to a user interaction with the highlighted text pattern.

6. A method according to claim 1, wherein the parts include a country code part.

7. A method according to claim 1, wherein the separating step includes determining whether the pattern can be separated into three parts consisting of a country code part, an area code part and a local part.

8. A method according to claim 7, further comprising setting the country code part to the number 1 if a first portion of the pattern is not a country code.

9. A method according to claim 1, further comprising converting letters in the pattern to numbers in accordance with a mapping between the letters and numbers on a conventional telephone keypad.

10. A method according to claim 1, wherein the text source comprises an HTML page that is being rendered for display to a user by a browser.

11. A method according to claim 10, further comprising:
highlighting the text pattern on a display if the separated parts form the valid telephone number; and
enabling a user to launch a voice application by clicking on the highlighted text pattern.

12. A method according to claim 11, further comprising:
recording the clicking on the highlighted text pattern;
associating the recorded click with a company associated with the HTML page, wherein the valid telephone number is also associated with the company.

13. A method comprising:
receiving a text source;
searching the text source for a series of characters;
determining whether the series of characters contain a telephone number, including:
determining whether the telephone number comprises a vanity number, and
determining whether the telephone number comprises an international number.

14. A method according to claim 13, further comprising formatting the series of characters into an output that can be used to launch a voice application if the series of characters contain the telephone number.

15. A method according to claim 13, further comprising:
if the series of characters comprises the international number,
determining a country code included in the international number;
determining whether the remaining characters in the series of characters contain a valid number for dialing a telephone in a country associated with the country code.

16. A method according to claim 13, wherein the step of determining whether the series of characters comprises the international number includes determining whether the series of characters can be separated into three parts consisting of a country code part, an area code part and a local part.

17. A method according to claim 13, further comprising:
if the series of characters comprises the vanity number, converting letters in the series of characters to numbers in accordance with a mapping between the letters and numbers on a conventional telephone keypad.

18. A method comprising:
displaying a web page in a browser;
causing the browser to highlight a phone number in the displayed web page;
linking the highlighted phone number with a VoIP dialing application; and
launching a VoIP call in response to a click on the highlighted phone number in the browser.

19. A method according to claim 18, further comprising:
causing the web page to be sent to the browser from a server; and
detecting the click at the server.

20. A method according to claim 19, wherein the server comprises a search engine.
